(19) United States
(12) Patent Application Publication
(10) Pub. No.: US 2003/0185578 A1
(43) Pub. Date: Oct. 2, 2003

(54) Receiving device for disturbed optical signals with generation of a feedback signal by correlation, and method of generating such a feedback signal

(75) Inventor: Fred Buchali, Waiblingen (DE)

Correspondence Address: SUGHRUE MION, PLLC, 2100 PENNSYLVANIA AVENUE, N.W., WASHINGTON, DC, 20037, US

(73) Assignee: ALCATEL

(21) Appl. No.: 10/397,415

(22) Filed: Mar. 27, 2003

(30) Foreign Application Priority Data
Mar. 28, 2002 (EP) 02 360 112.3
Mar. 29, 2002 (EP) 02 290 811.5

(51) Int. Cl. H04B 10/06

(52) U.S. Cl. 398/209; 398/202

(57) ABSTRACT

A receiving device for an optical signal that is impaired by disturbances, wherein the receiving device has an adaptive filter device that serves to compensate at least partly for disturbances in the optical signal and that is controlled by a feedback signal is characterized in that the feedback signal is generated by correlating the optical signal with a further signal that is formed with respect to the optical signal in such a way that, in the absence of disturbances in the optical signal, at most a slight correlation is present.

### BACKGROUND OF THE INVENTION

The invention is based on a priority application EP 02290811.5 which is hereby incorporated by reference.

The invention relates to a receiving device for an optical signal that is impaired by disturbances, the receiving device having an adaptive filter device that serves to compensate at least partly for disturbances in the optical signal and that is controlled by a feedback signal.

The transmission of optical signals via optical waveguides is subject to numerous disturbing effects, for which reason the disturbed optical signal is regenerated by an adaptive filter device prior to detection or other subsequent processing. The signal transmission may proceed by means of optical signals, for example, by means of high-density wavelength-division multiplexing (HDWDM), it may take place in local networks (LANs) and disturbances may occur as a result of polarization-mode dispersion (PMD), chromatic dispersion (GVD, group-velocity dispersion) and nonlinearities. In the case of the last named disturbance, the phase position of the pulses changes during the transmission. Feedback signals that can be obtained at the receiving end are necessary to control the abovementioned adaptive filter devices. It is already known to generate optical feedback signals, for example degree-of-polarization (DOP) signals or electrical correction signals (bit error ratio). The known adaptive filter devices and filter methods do not, however, satisfy all the requirements, in particular when high bit transmission rates are involved. This applies also to methods of generating feedback signals.

### SUMMARY OF THE INVENTION

The invention creates a novel generation of feedback signals. The invention is characterized in that the feedback signal is generated by correlating the optical signal with a further signal that is formed with respect to the optical signal in such a way that, in the absence of disturbances in the optical signal, there is a correlation that is smaller than the maximum possible correlation to the two signals. This applies, in particular, also to that correlation that is described here as “maximum possible” and that is achievable by suitable matching of the phase position of the two signals.

Preferably, in the absence of disturbances in the optical signal, the existing correlation is at most in the region of 50% of the maximum possible correlation of the two signals.

Furthermore, it is preferred that in the absence of disturbances in the optical signal, there is at most a slight correlation.

The two last named embodiments offer advantages with respect to the closed-loop control capability since the closed-loop control does not take place in the immediate vicinity of the maximum possible correlation or of the correlation with the correlation factor zero, that is to say in regions of low control gradient.

The invention is based on the following insight: if an undisturbed optical signal, which in general always occurs as a sequence of signal bits, is correlated with a further signal that does not have any correlation with the said optical signal, the correlation of the two signals results in the correlation factor zero. Such an uncorrelated system may, for example, be the exact copy of the undisturbed optical signal, which is, however, shifted with respect to the latter by about half a bit spacing (in the case of RZ signals, return-to-zero signals) or about one whole bit spacing (in the case of NRZ signals, no-return-to-zero signals), that is to say it must always have the logic value zero if the undisturbed optical signal may have, depending on information content, a logic level 1 (or perhaps also 0), and the said shifted further signal may always have a level deviating from zero if the undisturbed optical signal (in a pause between consecutive bits) has the level zero. At any instant, the analog multiplication of the instantaneous signal amplitude of the two signals results in the value zero, that is to say likewise the correlation factor zero integrated over a certain time.

If distortions now occur in the original optical signal, this results in a deviation of the precise pulse shape in the direction of a widening of the pulse shape, with the result that a value different from zero occurs when the correlation is determined. This correlation factor may be used, according to the invention, as a feedback signal.

Since the original undisturbed signal shape of the optical signal is to be restored as well as possible by the feedback signal (which would result in a correlation factor of zero in the abovementioned example), the procedure adopted is preferably such that even in the case of a sufficiently ideal original optical signal, a correlation factor markedly different from zero is already determined by the correlation. Said correlation factor may not then drop to zero in the case of closed-loop control in the direction of a reduction of the correlation factor, with the result that the closed-loop control capability of the receiving device or of the method is always maintained.

A closed-loop control in the sense that an increase in the correlation occurs would in general have the result that the received, already disturbed optical signal is artificially disturbed still more strongly. Nevertheless, the case may occur where such a closed-loop control towards a maximizing of the correlation is advantageous.

Instead of the abovementioned received signal shifted by half a bit width or a whole bit width as further signal that is compared with the (unshifted) received optical signal by a correlation calculation, a signal present at the receiving end or generated artificially there may also be used that is constructed in such a way that it is not correlated with the received signal. As such a further signal, for example, use can be made of another optical signal that is fed over the receiving path of the receiving device and whose signal content has nothing in common with the optical signal to be corrected (to be equalized) and is therefore not correlated with it (further communication channel of the WDM system). In either case, it may be that another optical signal of this type still has slight correlation with the signal to be equalized, for example because both signals coincide in regard to the structure of the frames used. The above comments reveal that such a slight correlation still found may be quite useful for executing the method because perfect closed-loop control to the correlation factor of zero cannot take place.

Optical signals are in general very broadband. The abovementioned time shift by about half a bit spacing (or by about a whole bit spacing) has the result that a change in the pulse width in the high frequency part of the spectrum has an effect in the calculation of the correlation. If it is intended, on the other hand, to utilize a change in the pulse widths for the correlation at lower frequencies of the spectrum of the optical signals, this can be done by using, instead of a delay by about half a bit width in the case of RZ signals, delays by about three half bit widths, five half bit widths, seven half bit widths and so on and, in the case of NRZ signals, delays by about two, three, four bit widths and so on. This results in increasingly lower frequencies in the spectrum at which the correlation is calculated.

The invention also relates to a method of generating a feedback signal for an adaptive filtering that regenerates an optical signal at the receiving end, said method comprising the steps already explained above.

The invention also relates to a method of generating a feedback signal that is suitable for the control of an adaptive filter device for the purpose of compensating for disturbances in an optical signal. According to the invention, the method comprises the steps already explained above and is characterized in that the feedback signal is generated by correlating the optical signal with a further signal that is formed with respect to the optical signal in such a way that, in the absence of disturbances in the optical signal, there is a correlation that is smaller than the maximum possible correlation of the two signals. This applies, in particular, also to that correlation that is described here as “maximum possible” and that is achievable by a suitable matching of the phase position of the two signals. In this connection, a correlation of not more than about 50% of the maximum possible correlation is preferably present. This may offer advantages with respect to the closed-loop control capability.

At present, it is preferred that the feedback signal is generated by correlating the optical signal with a further signal that is formed with respect to the optical signal in such a way that, in the absence of disturbances in the optical signal, there is not more than a slight correlation. This may also be advantageous with respect to the closed-loop control capability.

Advantages of the invention are that, to generate the feedback signal by calculating the correlation, no decisions have to be made as to whether a value one or zero is present in each case, but the correlation can be calculated in a purely analog manner, with the result that, even in the case of a very high bit sequence frequency, in particular higher than 10 Gbit/s, standard, inexpensive analog multipliers can be used. Clock recovery or a threshold-value decision for the purpose of generating the feedback signal is unnecessary.

Further features and advantages of the invention emerge from the following description of exemplary embodiments of the invention with reference to the drawing, which shows details essential to the invention, and from the claims. The individual features may each be individually implemented separately or multiply in any combination in an embodiment of the invention.

### BRIEF DESCRIPTION OF THE DRAWINGS

FIG. 1 shows a functional diagram,

FIG. 2 shows diagrammatically a receiving device for an optical signal having an adaptive filter device for the purpose of recovering the optical signal from the disturbed signal, the feedback signal being generated with the aid of a correlation calculating device.

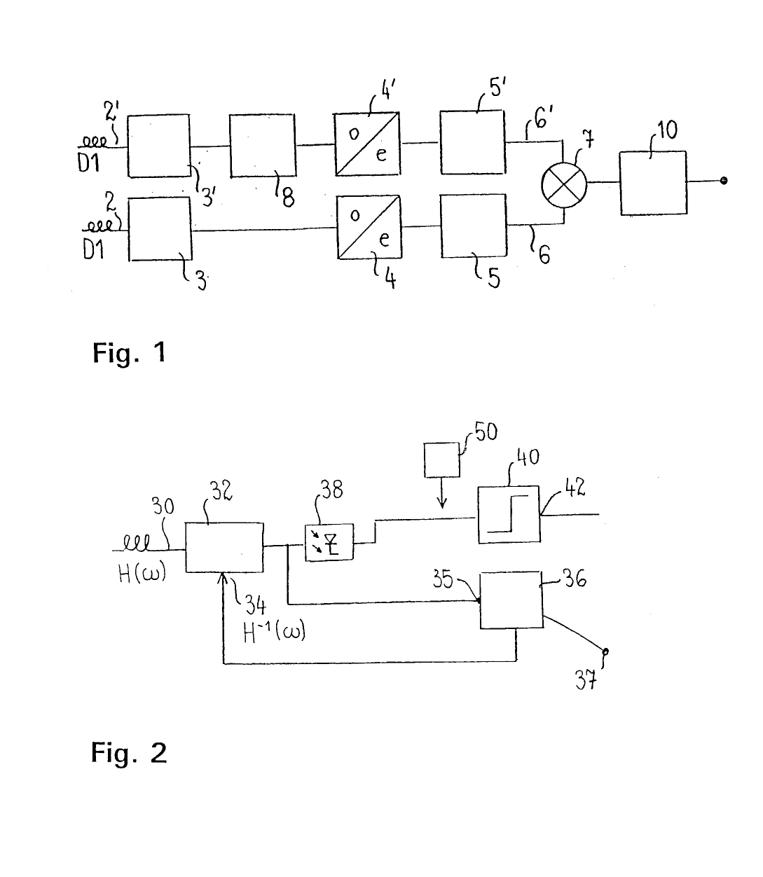

FIG. 1 shows a functional diagram for the formation of the feedback signal that initially takes place on the basis of determining the correlation by means of a time-shifted copy of the received optical signal. In a lower branch of the arrangement, a disturbed optical signal D1 reaches, over an optical path 2 via a suitable optical filter device 3, an optoelectrical converter 4 and, from the output of the latter, reaches an input of an analog multiplier 7 via an electrical filter device 5 via a path 6. In the upper branch of the arrangement of FIG. 1, the disturbed optical data D1 reach, over an optical path 2′, the input of an optical filter device 3′ and, from the output of the latter reaches, via an optical delay device (in practice, a certain length of an optical waveguide) 8, the input of a further optoelectrical converter 4′ and, from the latter reaches a further electrical filter device 5′ and, from the output of the latter, reaches a further input of the analog multiplier 7 via a further path 6′. The respective output signal of the analog multiplier 7 (that is to say the product of the two input signals) is fed to an integration device 10 at whose output a direct voltage appears that is a measure of the correlation factor.

The delay device 3 makes it possible to set a suitable time delay that is, in particular, in the region of the length in time of one bit of the optical signal.

In another embodiment of the invention, instead of a copy of the disturbed optical signal D1 that is fed to the upper branch of FIG. 1, an optical signal D2 (not shown in FIG. 1) is provided that is not related in any way to the optical signal to be received and to be equalized.

FIG. 2 shows a block circuit diagram of an optical transmission system in which an adaptive filtering is undertaken at the receiving end for the purpose of equalization, the adaptive filtering being controlled by a feedback signal generated by means of correlation calculation. Over a path 30 symbolically shown as an optical waveguide, an optical signal disturbed by the disturbance function H (omega) reaches an input of a compensator 32 that is capable of undertaking a compensation for the disturbances over the optical transmission path by means of an inverse function H⁻¹ (omega). The compensator 32 is controlled by a feedback signal that is fed to an input 34 of the compensator. Said feedback signal is the output signal, explained above by reference to FIG. 1, of the correlation device (analog multiplier with downstream integrator), which is provided here with the reference symbol 36.

In the example, it is assumed that the most important cause of the disturbances is the polarization-mode dispersion. Consequently, the compensator 32 comprises the following elements: it essentially comprises a polarization controller and a polarization-maintaining fibre (PMF). Such a compensator is already known but not in connection with the injection by a feedback signal that is determined by correlation calculation.

The compensated optical signal appearing at the output of the compensator is converted by means of an optoelectrical converter 38, shown symbolically as a photodiode, into an electrical signal and demodulated by means of a threshold-value circuit 40. At the output 42 of the threshold-value circuit 40, there appears the demodulated signal that, depending on requirements, is now again placed on an optical transmission path or is forwarded for further processing. The signal between the elements 32 and 38 is fed to an input 35 of a correlator 36. In the example, the same signal as is fed to the input 35 is fed to a further input 37 in another embodiment, with some time delay, as explained above. An electrical compensator 50 for compensating for disturbances by means of the feedback signal obtained by correlation is also indicated, which, in a first modification of FIG. 2 described hitherto, is present in addition to the device 32, and in a second modification, is present instead of the device 32. In this connection, in the two last named cases, the electrical compensator 50 is connected via a conductor in embodiments containing the conductor connecting the elements 38 and 40, while in other exemplary embodiments, the electrical compensator 50 is inserted into the conductor connecting the elements 38 and 40.

The following is also pointed out: it is known to test largely similar signals having unknown phase shift for correlation and, in that case, to alter the phase shift so as to achieve a maximum correlation (equals maximum time coincidence) of the two signals, whereupon the latter can be detected, for example, particularly effectively. This known procedure deviates from the procedure in accordance with the device according to the invention or the method according to the invention. The invention can namely be applied in such a way and is preferably applied in such a way that, after setting a time delay between two signals to be subjected to a correlation calculation in the above-described way, said time delay is not changed for the purpose of altering the correlation.

1. Receiving device for an optical signal that is impaired by disturbances, wherein the receiving device has an adaptive filter device that serves to compensate at least partly for disturbances in the optical signal and that is controlled by a feedback signal, comprising the feedback signal is generated by correlating the optical signal with a further signal that is formed with respect to the optical signal in such a way that, in the absence of disturbances in the optical signal, there is a correlation that is smaller than the maximum possible correlation to the two signals.

2. Receiving device according to claim 1, comprising in the absence of disturbances in the optical signal, the existing correlation is at most in the region of 50% of the maximum possible correlation of the two signals.

3. Receiving device according to claim 1, comprising in the absence of disturbances in the optical signal, there is at most a slight correlation.

4. Receiving device according to claim 1, comprising the further signal is a time-shifted copy of the optical signal.

5. Receiving device according to claim 1, comprising the further signal is formed from an optical signal that is available in the receiving device and that is not related in any way to the said optical signal.

6. Receiving device according to claim 1, comprising the further signal is an artificial signal generated at the position of the receiving device.

7. Receiving device according to claim 1, comprising the adaptive filter device is formed in such a way that the correlation is influenced in the sense of maximization.

8. Receiving device according to claim 1, comprising the adaptive filter device is formed in such a way that the correlation is influenced in the sense of minimization.

9. Method of generating a feedback signal that is suitable for the open-loop control of an adaptive filter device for the purpose of compensating for disturbances in an optical signal, comprising the feedback signal is generated by correlating the optical signal with a further signal that is formed with respect to the optical signal in such a way that, in the absence of disturbances in the optical signal, there is a correlation that is smaller than the maximum possible correlation of the two signals.

10. Method according to claim 9, comprising the feedback signal is generated by correlating the optical signal with a further signal that is formed with respect to the optical signal in such a way that, in the absence of disturbances in the optical signal, there is not more than a slight correlation.
